(19) United States
(12) Patent Application Publication
(10) Pub. No.: US 2025/0257704 A1
(43) Pub. Date: Aug. 14, 2025

(54) LEAK DETECTION MODULE ENTROPY METHOD WITH VARIABLE SPEED PUMP FOR EVAPORATIVE EMISSIONS SYSTEM

(71) Applicant: Stoneridge Control Devices, Inc., Novi, MI (US)

(72) Inventors: Mark W. Peters, Wolverine Lake, MI (US); Robert James Steinman, Lexington, OH (US)

(21) Appl. No.: 19/049,314

(22) Filed: Feb. 10, 2025

Related U.S. Application Data
(60) Provisional application No. 63/553,449, filed on Feb. 14, 2024.

(51) Int. Cl. F02M 25/08; G01M 3/26

(52) U.S. Cl. CPC F02M 25/0818; G01M 3/26

(57) ABSTRACT

A method of detecting a leak in an evaporative emissions system includes sealing a system, operating a variable speed pump at a first speed to reach a first target pressure in the system, monitoring an actual pressure in the system, determining whether an error between the actual pressure and the first target pressure exceeds a threshold, and operating the variable speed pump at a second speed different than the first speed when the error exceeds the threshold to reach a second target pressure different than the first target pressure.

### CROSS-REFERENCE TO RELATED APPLICATION

This application claims priority to Untied States Provisional Application No. 63/553,449 filed Feb. 14, 2024.

### TECHNICAL FIELD

This disclosure relates to a method of performing a leak test on an evaporative emissions system of a gasoline powered vehicle, and to a system having a variable speed pump used to perform the method.

### BACKGROUND

Evaporative emissions systems have long been required for gasoline powered vehicles. The system must undergo a leak test during a vehicle start-up procedure to ensure that fuel vapors will not leak into the atmosphere. A constant speed pump (energized to a set speed, which is maintained) is used either to create a vacuum or pressurize the system. An external filter is used to prevent contamination that could damage the pump or other components of the system during operation. Various valves may be closed during this test procedure to maintain system pressure, and the pressure is monitored once a target pressure has been reached to determine if there are any leaks.

When a leak is present in the evaporative system at high ambient temperatures (>35° C.), gasoline vapors (VOC) vented through the leak exceeds the design intent of a properly functioning evaporative system. Over the course of 24 hours, the gases released through a 1.0 mm leak from the vapor dome of the fuel tank can exceed evaporative leak regulations by more than 10 times the allowable amount. Therefore, it is desirable to provide an evaporative emissions system leak test that is able to quickly and accurately detect a leak in the system. The effects of entropy on the system during the leak test procedure makes it difficult to perform the test quickly and accurately.

### SUMMARY

In one exemplary embodiment, a method of detecting a leak in an evaporative emissions system includes sealing a system, operating a variable speed pump at a first speed to reach a first target pressure in the system, monitoring an actual pressure in the system, determining whether an error between the actual pressure and the first target pressure exceeds a threshold, and operating the variable speed pump at a second speed different than the first speed when the error exceeds the threshold to reach a second target pressure different than the first target pressure.

In a further embodiment of any of the above, the system has a predicted pressure curve for a leak test procedure. The predicted pressure curve includes the first target pressure and the second target pressure.

In a further embodiment of any of the above, the threshold corresponds to a permissible difference between the actual pressure and the first target pressure.

In a further embodiment of any of the above, the monitoring, determining and operating steps are repeated such that the variable speed pump is operated at different speeds until a final test pressure in the system is obtained.

In a further embodiment of any of the above, the variable speed pump is operated at successively increasing speeds over time until reaching the final test pressure.

In a further embodiment of any of the above, the variable speed pump is operated at increasing and decreasing speeds over time until reaching the final test pressure.

In a further embodiment of any of the above, the increasing and decreasing speeds are performed to cause the actual pressure to be greater than and less than the predicted pressure curve during the leak test procedure.

In a further embodiment of any of the above, the first target pressure variable speed pump operating step and the second target pressure variable speed pump operating step are performed by pulling a vacuum on the system.

In a further embodiment of any of the above, the system includes components that include a fuel filler and cap, a purge valve, a charcoal canister, a vapor dome of a fuel tank, vapor lines that fluidly connect the components, a pressure transducer that is fluidly connected to the components and the vapor lines, and a valve. The sealing step includes closing the valve to close off the system to atmosphere, and the monitoring step includes measuring the actual pressure with the pressure transducer.

In a further embodiment of any of the above, a leak test condition includes at least one of a no leak condition, very small leak condition and small leak condition, and includes a step of generating an engine malfunction code with an onboard diagnostic system in response to each of the very small leak condition and small leak condition.

In another exemplary embodiment, an evaporative emissions system includes a fuel tank with a fuel filler and a cap. The fuel tank is configured to contain fuel and fuel vapors, a charcoal canister that is configured to store the fuel vapors from the fuel tank, a purge valve in fluid communication with the charcoal canister and configured to selectively provide the fuel vapors to an engine in response to a purge command, a leak detection module that includes a canister valve solenoid, a variable speed pump, a check valve, a first fluid passageway that fluidly connects the canister valve solenoid to atmosphere, a second fluid passageway that fluidly connects the charcoal canister to the variable speed pump through the check valve, and the variable speed pump fluidly arranged between the check valve and atmosphere. A pressure transducer is in fluid communication with the variable speed pump. A controller is in communication with the canister valve solenoid and the pressure transducer. The controller is configured to run a leak test procedure that includes sealing the evaporative emissions system, operating a variable speed pump at a first speed to reach a first target pressure in the evaporative emissions system, monitoring an actual pressure with the pressure transducer, determining whether an error between the actual pressure and the first target pressure exceeds a threshold, and operating the variable speed pump at a second speed different than the first speed when the error exceeds the threshold to reach a second target pressure different than the first target pressure.

In a further embodiment of any of the above, the evaporative emissions system has a predicted pressure curve for the leak test procedure. The predicted pressure curve includes the first target pressure and the second target pressure.

In a further embodiment of any of the above, the threshold corresponds to a permissible difference between the actual pressure and the first target pressure.

In a further embodiment of any of the above, the monitoring, determining and operating steps are repeated such that the variable speed pump is operated at different speeds until a final test pressure in the evaporative emissions system is obtained.

In a further embodiment of any of the above, the variable speed pump is operated at successively increasing speeds over time until reaching the final test pressure.

In a further embodiment of any of the above, the variable speed pump is operated at increasing and decreasing speeds over time until reaching the final test pressure.

In a further embodiment of any of the above, the increasing and decreasing speeds are performed to cause the actual pressure to be greater than and less than the predicted pressure curve during the leak test procedure.

In a further embodiment of any of the above, the first target pressure variable speed pump operating step and the second target pressure variable speed pump operating step are performed by pulling a vacuum on the evaporative emissions system.

In a further embodiment of any of the above, a leak test condition includes at least one of a no leak condition, very small leak condition and small leak condition, and includes a step of generating an engine malfunction code with an onboard diagnostic system in response to each of the very small leak condition and small leak condition.

### BRIEF DESCRIPTION OF THE DRAWINGS

The disclosure can be further understood by reference to the following detailed description when considered in connection with the accompanying drawings wherein:

FIG. 1 schematically illustrates portions of one example evaporative fuel system.

FIG. 2 is a schematic view of a leak detection module (LDM) for the system shown in FIG. 1.

FIG. 2A is a schematic of the LDM configured to operate the system at a negative pressure (vacuum) during a leak test procedure.

FIG. 2B is a schematic of the LDM configured to operate the system at a positive pressure (pressurized) during the leak test procedure.

FIG. 3 is a graph illustrating the prior art entropy curves of an aluminum fuel tank and of fuel vapor in the fuel tank in kPa v. J.

FIG. 4 is a graph of several leak rates (no leak (0.00″ Ø), very small leak (0.020″ Ø), small leak (0.040″ Ø) for fuel tank vacuum v. fuel level.

FIG. 5 is a flowchart depicting the leak check procedure.

FIG. 6 is a flowchart illustrating operation of a variable speed pump during the leak test procedure shown in FIG. 5.

FIGS. 7A and 7B graphically illustrate first and second example methods of operating the variable speed pump to achieve a final test pressure.

FIG. 8 is flow chart depicting an example leak detection method that minimizes the effects of entropy in the fuel tank another entropy mitigation approach once the final test pressure has been reached according to the method of FIG. 6.

FIG. 9 is a graph of the fuel vapor in the fuel tank in kPa v. J according the entropy mitigation approach in FIG. 8.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

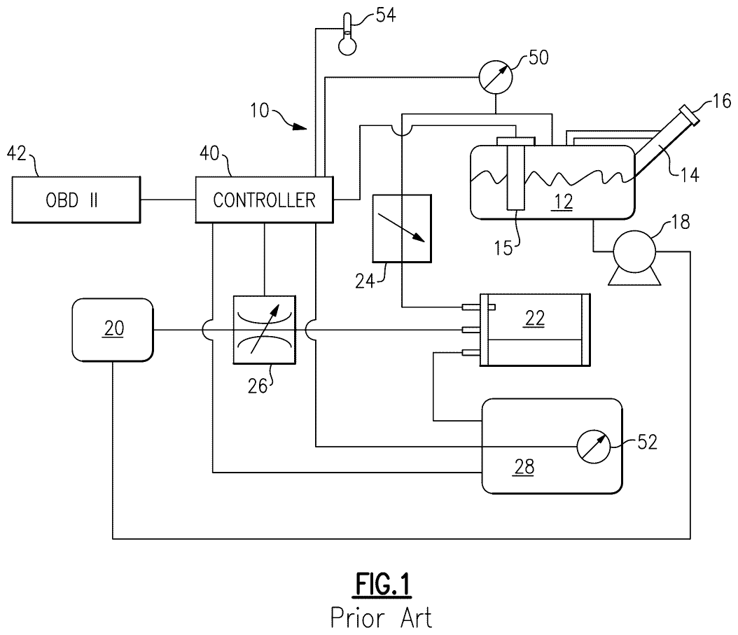

FIG. 1 schematically illustrates a portion of an example evaporative fuel system 10. The system 10 includes a fuel tank 12 having a fuel filler 14 with a fill cap 16. A fuel pump 18 supplies gasoline, for example, from the fuel tank 12 to an internal combustion engine 20. A fuel level sensor 15 is in communication with a controller 40 and measures a level of fuel within the fuel tank 12, which also correlates to an amount of fuel vapor within the fuel tank 12.

The system 10 is configured to capture and regulate the flow of fuel vapors within the system. In one example, a fuel tank isolation valve 24 is arranged fluidly between the fuel tank 12 and a charcoal canister 22, which captures and stores fuel vapors for later use by the engine 20. A purge valve 26 is fluidly connected between the canister 22 and the engine 20. The controller 40 regulates a position of the purge valve 26 to selectively provide the fuel vapors to the engine 20 during operation to make use of these fuel vapors.

The integrity of the system 10 must be periodically tested to ensure no fuel vapors can leak from the system 10. One type of system 10 uses a leak detection module (LDM) 28, which can be used to pull a vacuum and/or pressurize the system to determine whether a leak exists, for example, using a pressure transducer 52. In one example leak test procedure, the purge valve 26 is closed and the controller 40 operates the leak detection module 28 to evacuate or pressurize the system. Another pressure transducer 50 may be used to monitor the pressure of fuel vapors within the fuel tank 12 during other conditions. Either of both of the pressure sensors 50, 52 can be used during the leak test procedure. An ambient temperature sensor 54, which is optional, is in communication with the controller 40. The temperature sensor 54 may be useful for quantify heat transfer characteristics of the fuel vapor within the fuel tank 12 relative to surrounding atmospheric temperature.

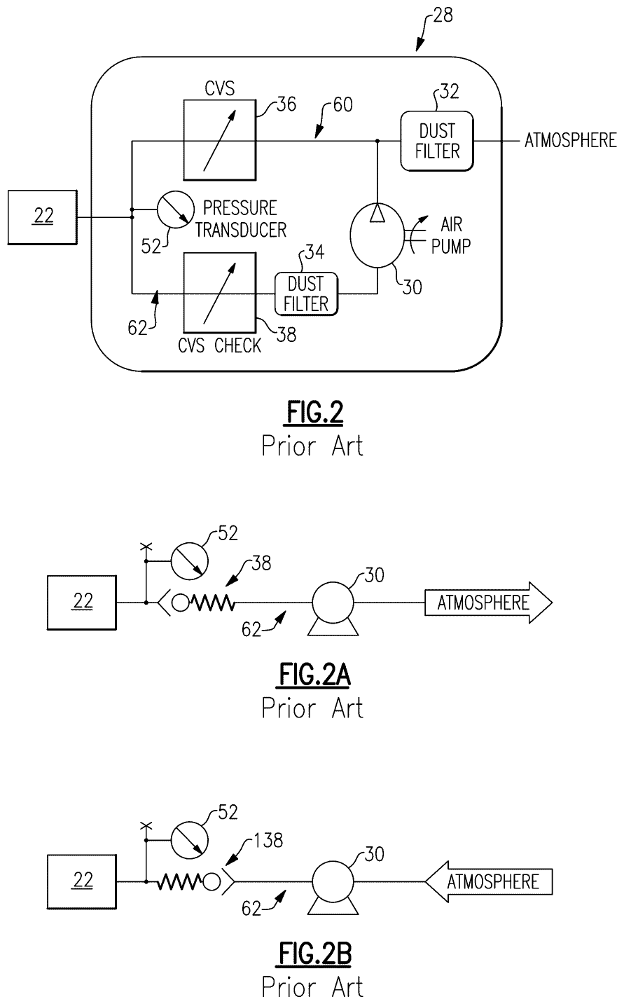

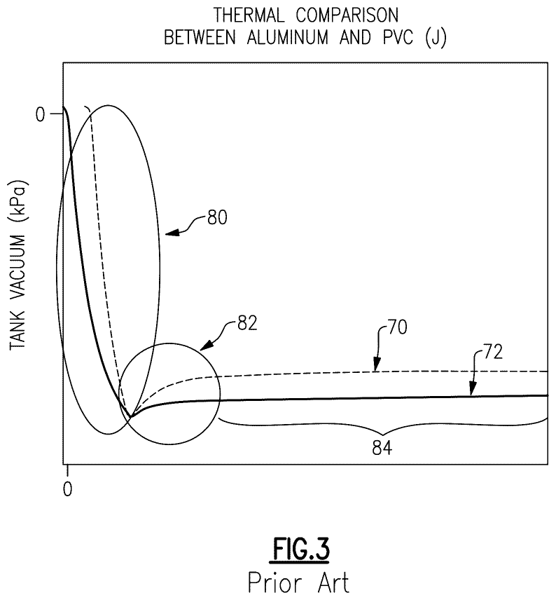

The example LDM 28 is schematically shown in FIG. 2. The LDM 28 includes a variable speed pump 30 arranged in a housing. Some customers prefer a system that operates using a vacuum, while other customers prefer a system that is pressurized. So, to provide a pressurized evaporative emissions system test, the variable speed pump 30 will draw air from atmosphere through a filter 32 and direct the air towards the canister 22. Another filter 34 may be provided on the other side of the variable speed pump 30 to protect the pump from debris. To provide a depressurized or negative pressure evaporative emissions system test (i.e., vacuum), the variable speed pump 30 will draw air from the canister 22 and out to the atmosphere.

When the LDM 28 is not performing a leak check of the fuel system 10, a canister valve solenoid (CVS) 36 is in an open position to allow air to pass through a first fluid passageway 60 between the rest of the system 10 and atmosphere. This enables the system 10 to draw air from the atmosphere as needed.

When the LDM 28 is performing a leak test of the of the fuel system 10, the CVS 36 is in a closed position, which provides a second fluid passageway 62 on the side of the canister 22. A CVS check valve 38 is arranged in the second fluid passageway 62 and selectively blocks the canister 22 from the variable speed pump 30 and atmosphere. The pressure transducer 52 is arranged to read the pressure in the second fluid passageway 62 when the CVS 36 is closed, although the pressure transducer can be used for other purposes.

The LDM 28 contains the hardware necessary to determine if the system 10 has a leak to atmosphere. During a leak test, depending upon how the CVS check valve that is used to decouple the variable speed pump 30 from the volume of air that is being check for leaks. variable speed FIG. 2A schematically illustrates the CVS check valve 38 for a negative pressure leak test, and FIG. 2B schematically illustrates the CVS check valve 138 for a positive pressure leak test. The leak boundary of the system 10 includes the fuel filler 14 and cap 16, the purge valve 26, the fresh air side of the canister 22 (side connected to the LDM 28), the vapor dome of the fuel tank 12, and vapor lines connecting all components, including the second fluid passageway 62. It should be understood that other types of valve configurations may be used to perform the leak test procedure.

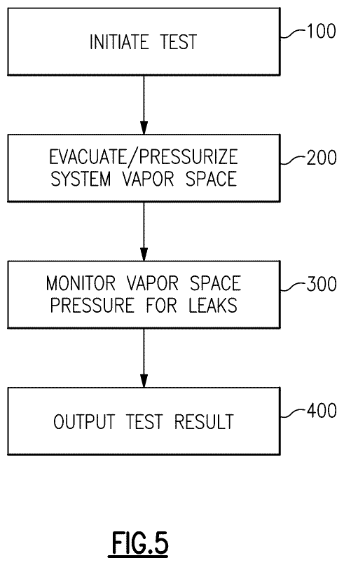

A typical leak test procedure is shown in FIG. 5. The test is initiated (block 100) at a desired time (e.g., after the vehicle has ceased operation), and the system 10 is sealed. A pump is operated to achieve a desired test pressure (either a vacuum or positive pressure) in the sealed vapor space (block 200). Once at the desired test pressure, the pressure within the sealed vapor space is monitored for changes, which would be indicative of a leak (block 300). The result of the test is output (block 400).

During the leak test, using the example system 10 shown in FIGS. 1 and 2, the pressure transducer 52 is in fluid communication with the second fluid passageway 62 and monitors the pressure condition generated by the pump 60 in the system 10. The pressure transducer 52 is in communication with the controller 40, which determines if there is a variation in pressure over a predetermined amount of time in the evaporative emissions system that might indicate a leak. Any change in pressure detected by the pressure transducer 52, which is monitored by the controller 40, is indicative of a leak. An OBDII diagnostics system 42 communicates with the controller 42 and uses the pressure information from the pressure transducer to generate engine malfunction codes that may be stored and for illuminating a “check engine” light on the vehicle instrument panel indicating vehicle service is needed.

The controller 40 and OBDII system 42 may be integrated or separate. In terms of hardware architecture, such a controller can include a processor, memory, and one or more input and/or output (I/O) device interface(s) that are communicatively coupled via a local interface. The local interface can include, for example but not limited to, one or more buses and/or other wired (e.g., CAN, LIN and/or LAN) or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller may be a hardware device for executing software, particularly software stored in memory. The processor can be a custom made or commercially available processor, a central processing unit (CPU), an auxiliary processor among several processors associated with the controller, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, etc.). Moreover, the memory may incorporate electronic, magnetic, optical, and/or other types of storage media. The memory can also have a distributed architecture, where various components are situated remotely from one another, but can be accessed by the controller.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

When the controller is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

Turning to FIG. 3, the effects of entropy with the system 10 make quick and efficient leak detection more difficult. A typical leak test is performed by evacuating (shown; or pressurizing) the fuel tank 12 to a target pressure. For a fuel tank in equilibrium, the temperature in the tank decreases as the vacuum increases resulting in a temperature differential across the fuel tank wall to atmosphere. The effects of entropy on the fuel tank wall and the fuel vapor within the fuel tank 12 is respectively illustrated by the first portion 80 of the curves 70 (aluminum tank wall) and 72 (PVC tank wall). The heat transfer between the fuel tank material and the fuel vapor is also depicted by the transition 82 between the first portion 80 and second portion 84 of the curves 70, 72.

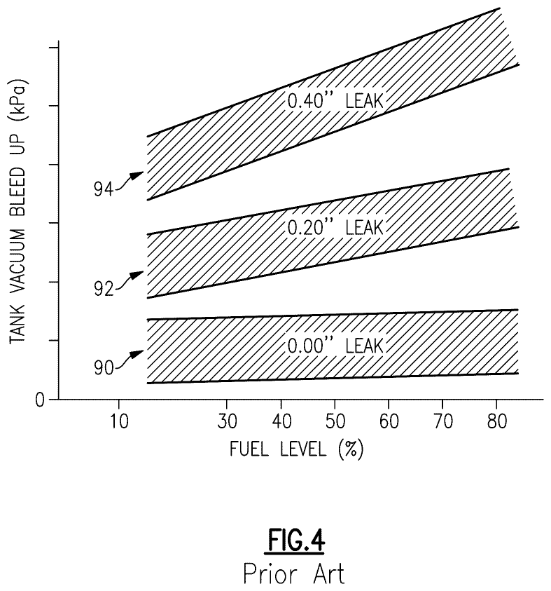

The FIG. 4 graph illustrates several leak rates during the hold period (second portion 84) during the test. A system leak can be a summation of multiple small leaks. A “no leak” condition (0.00 inch Ø leak in the system 10) is shown by pressure distribution 90, which is sensed by the pressure transducer 52. It should be understood that even a “no leak” condition may not be airtight after a minute or so. A very small leak condition (equivalent to about a 0.020 inch Ø leak in the system 10 up to about a 0.040 inch Ø leak) is shown by the pressure distribution 92, which may be interpreted by the OBDII diagnostic system 42 as a “very small leak” corresponding to an engine malfunction code of P0456, for example. A small leak condition (equivalent to about a 0.040 inch Ø leak or greater in the system 10) is shown by the pressure distribution 94, which may be interpreted by the OBDII diagnostic system 42 as a “small leak” corresponding to an engine malfunction code of P0442, for example. The bleed up concept may not apply to a gross leak due to the inability to actually evacuate a system to target vacuum with a predetermined time, and this gross leak condition would may also result in an OBDII code.

Literature had suggested that for a given temperature, fuel vaporization in a vacuum condition, is linear and results with a linear change in pressure. However, testing has not provided linear results. This is due to the non-linear response in the change in entropy, vapor pressure and heat transfer. After target vacuums are reached and the system is sealed, the pressure decays first at a non-linear rate and then becomes linear. The magnitude of the non-linear response is a function of ambient temperature. The slope of the linear response is a result of fuel vaporization. For fuel of the same volatility, vaporization increases with temperature. The non-linear response is common to both vacuum and pressure systems. System entropy changes as a function of pressure change. Evacuating a sealed tank results in a decrease in entropy (decrease in temperature), and pressurizing a sealed tank results in an increase in entropy (increase in temperature).

The rate of heat transfer is a function of fuel tank material and temperature differential. For a fuel tank in equilibrium, the temperature in the tank decreases as the vacuum (example shown) increases resulting in a temperature differential across the fuel tank wall to atmosphere. After the tank is sealed, heat flows through the tank shell back to the vapor space until the air space is again at equilibrium.

Eliminating the change in entropy is impossible due to the laws of physics, but the impact of this undesired entropy change can be mitigated. Fixed speed pumps (i.e., ON/OFF states, constant speed when ON) are used in evaporative emissions systems to obtain the desired target test pressure. The pump's flow rate to reach the desired target test pressure (by vacuum or pressurization) is a function of vapor space volume, leak size, system entropy and liquid (if any) vaporization rate. These factors all impact the time to achieve the desired target test pressure.

Based on empirical testing, fuel tank vapor entropy (thermal energy) typically stabilizes within 60 seconds of a change in system pressure. The change in system entropy also results with a change in liquid vaporization rates. If a system's pressure can increase or decrease in a predictable fashion, fuel vaporization and entropy rates, which results with increased variability, can be controlled. With an air pump where the motor has constant speed, the pump flow changes as a function of differential pressure across the vanes. This constant speed approach does not allow the system to minimize the impact of entropy or vaporization changes. As an example, if the pump can generate flow sufficient to reach 3 kPa pressure change in the presence of a 1.0 mm leak, then it has excessive flow capability when there are “zero” leaks in the system.

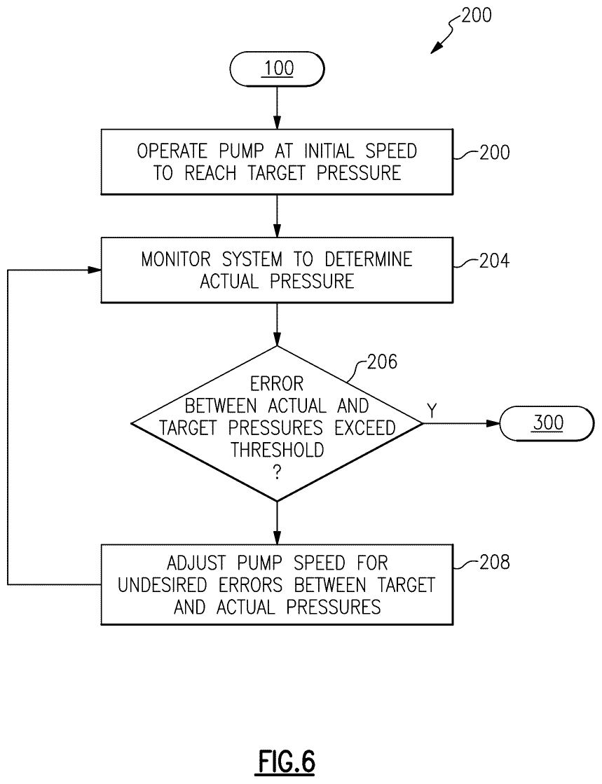

The disclosed method 200 shown in FIG. 6 mitigates the effects of entropy above by using the variable speed pump 30 instead of a fixed speed pump. The variable speed pump 30 includes an air pump (e.g., rotary vane pump) driven by a variable speed motor (e.g., a brushed or brushless DC motor where speed is controlled, for example, by a variable DC power supply, or a PWM supply voltage or control signal provided to a brushless DC motor controller).

Once the test has been initiated, typically with the system 10 already sealed (block 100), the variable speed pump 30 is operated at a first speed (which may be a preselected initial speed) to reach a first target pressure in the system 10 (block 202). The initial speed may be based upon fuel level, ambient temperature, initial pressure within the sealed system and/or other factors. Alternatively, the initial speed may be the same for each test regardless of the conditions. The actual pressure within the system 10 is monitored (block 204) by one or both of the pressure sensors 50, 52.

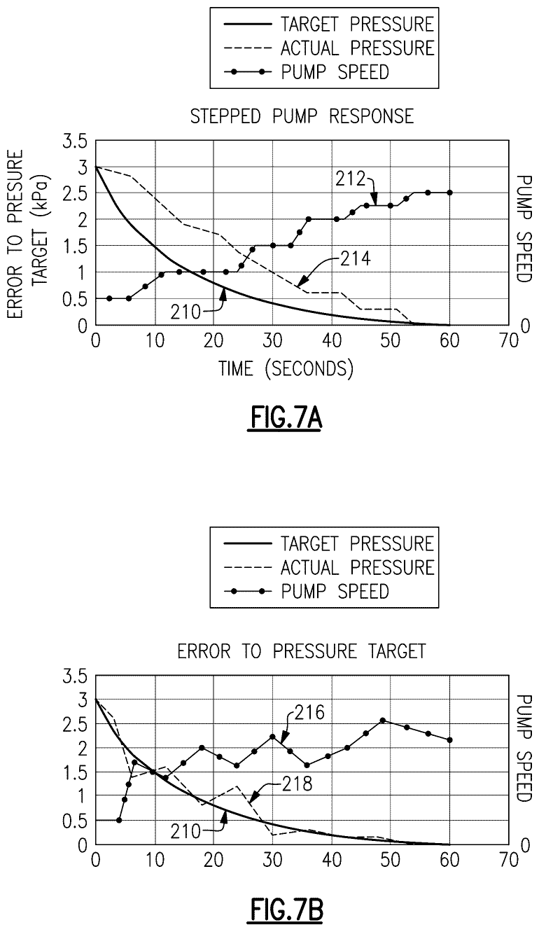

The system 10 has predicted pressure characteristics during a leak test procedure, which are illustrated by the predicted pressure curves 210 shown in FIGS. 7A and 7B (corresponding to two example approaches using the disclosed method). The predicted pressure may be stored for reference during the test in a memory of the controller 40, for example. The predicted pressure curve 210 includes multiple target pressures (e.g., first, second, third . . . target pressures) through the duration of the test. During the course of the test, the target pressures should necessarily be different as the system pressure is driven to the final test pressure.

The actual pressure in the system 10 during the test is monitored for comparison to the predicted pressure (i.e., the expected pressure during the test) to determine whether an error between the actual pressure and the first target pressure exceeds a threshold (block 206). This error, for example, can be expressed as a percentage or pressure value of the actual pressure within the predicted pressure (e.g., plus and/or minus X % of predicted pressure, or X psi of predicted pressure). The error would naturally continue to increase if the pump was operated as a fixed speed. The threshold corresponds to a permissible difference between the actual pressure and the target pressure (e.g., an error of 5% of the predicted pressure). The speed of the variable speed pump 30 is changed during the test, as needed, to stay within the desired error. Said another way, the variable speed pump 30 is operated at a second speed different than the first speed when the error exceeds the threshold to reach a second target pressure different than the first target pressure (block 208). Generally, the greater the error, then the greater the increase (or decrease) in pump speed.

The actual pressure monitoring may be performed continuously or at predetermined intervals (e.g., every 5 seconds), with each monitoring corresponding to a target pressure on the predicted pressure curve 210. Thus, steps 204, 206 and 208 are repeated until the final test pressure is obtained.

In the example variable speed pump control shown in FIG. 7A, the variable speed pump 30 is operated at successively increasing speeds (curve 212) over time until the actual pressure (curve 214) reaches the final test pressure. Pump speed increases in a known fashion if actual pressures do not cross predicted pressure curve trajectory. With this approach, pump speed is increased to approach or cross the predicted curve. But, if the flow is greater than required to achieve the predicted pressure, then the pump speed is not increased.

In the example variable speed pump control shown in FIG. 7B, the variable speed pump is operated at increasing and decreasing speeds (curve 216) over time until reaching the final test pressure. The increasing and decreasing speeds are performed to cause the actual pressure to be greater than and less than the predicted pressure curve (curve 218, pressure modulation) during the leak test procedure. This proportional control approach controls the pump flow to follow the predicted pressure curve by continuously increasing and decreasing speed based on the error to the target pressure (positive or negative error).

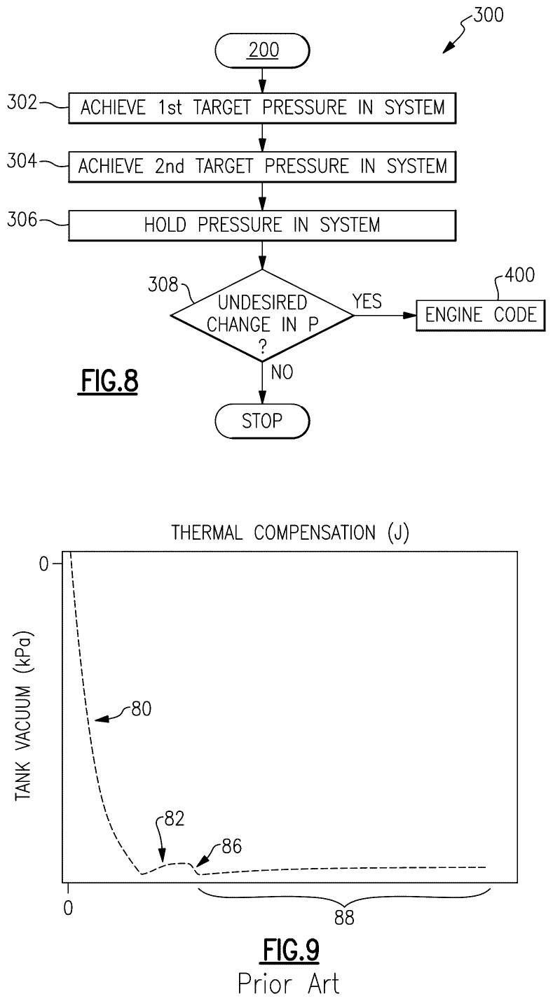

The disclosed method (FIG. 6) can be supplemented by additional entropy mitigation approaches, for example, using the system disclosed in WO2022/060794 filed on Sep. 15, 2021 and entitled “LEAK DETECTION MODULE ENTROPY METHOD FOR EVAPORATIVE EMISSIONS SYSTEM”, which is incorporated herein by reference in its entirety. Referring to FIGS. 8 and 9, this disclosed optional method 300 evacuates/pressurizes the system 10 to first final target pressure (block 302, first curve 80) while the system is sealed to allow heat exchange to occur (second curve 82), and then again evacuating/pressurizing the system 10 to a second final target pressure (block 302, third curve 86). The first and second final target pressures respectively correspond to a first and second entropy changes. The second entropy change is substantially less than the first entropy change, for example, 10% or less of the first entropy change.

The ambient temperature measured by the temperature sensor 54 can be used to determine, for example, how quickly to evacuate/pressurize the system 10 a second time based upon the heat transfer rate. In one example, the first and second target pressures are the same, for example, within 5% of one another. The duration of the second evacuation (or pressurization) can be significantly shorter than initial draw down, or first evacuation (or pressurization) resulting with less entropy change and thus less need for heat transfer. In one example, evacuating the system 10 the first and second times take a total of 15-120 seconds to achieve the target pressure at which time the system pressure is then held to determine if there is a pressure loss indicative of a leak. It may take longer or shorter depending upon the vapor space volume. Following this process results with a response due to leaks in the system and not the heat exchange, resulting in a relatively constant pressure (curve 88, shown for a no leak condition). Of course, additional evacuations (or pressurizations) may be performed, but the benefits will be much less compared to the second evacuation (or pressurization).

It is possible that pressure variation subsequent to the second evacuation (or pressurization) increases with a decrease in fuel level due to the greater exposure to the fuel tank wall temperature (bleed up in kPa for a negative pressure test; bleed down for a positive pressure test). The fuel level is measured by fuel level sensor 15. This pressure change during the relatively constant pressure curve 88 is illustrated by the upward sloping distributions in FIG. 4. Once the second final target pressure has been achieved the pressure is held (block 306), and the system 10 can be monitored for leaks (block 308).

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples. For example, the disclosed pump may be used in applications other than vehicle evaporative systems.

Although an example embodiment has been disclosed, a worker of ordinary skill in this art would recognize that certain modifications would come within the scope of the claims. For that reason, the following claims should be studied to determine their true scope and content.

What is claimed is:

1. A method of detecting a leak in an evaporative emissions system, comprising:
sealing a system;
operating a variable speed pump at a first speed to reach a first target pressure in the system;
monitoring an actual pressure in the system;
determining whether an error between the actual pressure and the first target pressure exceeds a threshold;
operating the variable speed pump at a second speed different than the first speed when the error exceeds the threshold to reach a second target pressure different than the first target pressure.

2. The method of claim 1, wherein the system has a predicted pressure curve for a leak test procedure, the predicted pressure curve including the first target pressure and the second target pressure.

3. The method of claim 2, wherein the threshold corresponds to a permissible difference between the actual pressure and the first target pressure.

4. The method of claim 3, wherein the monitoring, determining and operating steps are repeated such that the variable speed pump is operated at different speeds until a final test pressure in the system is obtained.

5. The method of claim 4, wherein the variable speed pump is operated at successively increasing speeds over time until reaching the final test pressure.

6. The method of claim 4, wherein the variable speed pump is operated at increasing and decreasing speeds over time until reaching the final test pressure.

7. The method of claim 6, wherein the increasing and decreasing speeds are performed to cause the actual pressure to be greater than and less than the predicted pressure curve during the leak test procedure.

8. The method of claim 1, wherein the first target pressure variable speed pump operating step and the second target pressure variable speed pump operating step are performed by pulling a vacuum on the system.

9. The method of claim 1, wherein the system includes components comprising:
a fuel filler and cap, a purge valve, a charcoal canister, a vapor dome of a fuel tank, vapor lines fluidly connecting the components, a pressure transducer fluidly connected to the components and the vapor lines, and a valve;
wherein the sealing step includes closing the valve to close off the system to atmosphere, and the monitoring step includes measuring the actual pressure with the pressure transducer.

10. The method of claim 9, wherein a leak test condition includes at least one of a no leak condition, very small leak condition and small leak condition, and comprising a step of generating an engine malfunction code with an onboard diagnostic system in response to each of the very small leak condition and small leak condition.

11. An evaporative emissions system comprising:
a fuel tank with a fuel filler and a cap, the fuel tank configured to contain fuel and fuel vapors;
a charcoal canister configured to store the fuel vapors from the fuel tank;
a purge valve in fluid communication with the charcoal canister and configured to selectively provide the fuel vapors to an engine in response to a purge command;
a leak detection module including a canister valve solenoid, a variable speed pump, a check valve, a first fluid passageway fluidly connecting the canister valve solenoid to atmosphere, a second fluid passageway fluidly connecting the charcoal canister to the variable speed pump through the check valve, the variable speed pump fluidly arranged between the check valve and atmosphere;
a pressure transducer in fluid communication with the variable speed pump;
a controller in communication with the canister valve solenoid and the pressure transducer, the controller configured to run a leak test procedure comprising:
sealing the evaporative emissions system;
operating a variable speed pump at a first speed to reach a first target pressure in the evaporative emissions system;
monitoring an actual pressure with the pressure transducer;
determining whether an error between the actual pressure and the first target pressure exceeds a threshold;
operating the variable speed pump at a second speed different than the first speed when the error exceeds the threshold to reach a second target pressure different than the first target pressure.

12. The system of claim 11, wherein the evaporative emissions system has a predicted pressure curve for the leak test procedure, the predicted pressure curve including the first target pressure and the second target pressure.

13. The system of claim 12, wherein the threshold corresponds to a permissible difference between the actual pressure and the first target pressure.

14. The system of claim 13, wherein the monitoring, determining and operating steps are repeated such that the variable speed pump is operated at different speeds until a final test pressure in the evaporative emissions system is obtained.

15. The system of claim 14, wherein the variable speed pump is operated at successively increasing speeds over time until reaching the final test pressure.

16. The system of claim 14, wherein the variable speed pump is operated at increasing and decreasing speeds over time until reaching the final test pressure.

17. The system of claim 16, wherein the increasing and decreasing speeds are performed to cause the actual pressure to be greater than and less than the predicted pressure curve during the leak test procedure.

18. The system of claim 11, wherein the first target pressure variable speed pump operating step and the second target pressure variable speed pump operating step are performed by pulling a vacuum on the evaporative emissions system.

19. The system of claim 11, wherein a leak test condition includes at least one of a no leak condition, very small leak condition and small leak condition, and comprising a step of generating an engine malfunction code with an onboard diagnostic system in response to each of the very small leak condition and small leak condition.
